(19) United States
(12) Patent Application Publication
(10) Pub. No.: US 2014/0068327 A1
(43) Pub. Date: Mar. 6, 2014

(54) APPARATUS AND METHOD FOR MANAGING A HANG STATE OF A MOBILE TERMINAL

(71) Applicant: PANTECH CO., LTD., Seoul (KR)

(72) Inventors: Seung-Hwan AN, Seoul (KR); Jung-Sun Sim, Seoul (KR); Ho-Rim Lee, Seoul (KR)

(73) Assignee: PANTECH CO., LTD., Seoul (KR)

(21) Appl. No.: 13/774,217

(22) Filed: Feb. 22, 2013

(30) Foreign Application Priority Data
Aug. 31, 2012 (KR) 10-2012-0096713

(51) Int. Cl. G06F 11/14

(52) U.S. Cl. CPC G06F 11/1402
USPC 714/15

(57) ABSTRACT

An apparatus and a method for managing a hang state of a mobile terminal are provided. The apparatus and method receives an input signal from a through an input device, such as a chip, independent of an Application Processor (AP) and detects and resolves the hang state. The apparatus includes an AP; an input device configured to receive an input and transmitting an input signal; an input processor configured to receive the input signal and transmit a notification signal to the AP; and a hang-state processor configured to determine that the AP is in a hang-state as the AP is not processing the input signal and the hang-state processor is further configured to remedy the hang-state of the AP, wherein upon receiving the notification signal the AP requests the input signal from the input processor.

### CROSS-REFERENCE TO RELATED APPLICATION

This application claims priority to and the benefit under 35 U.S.C. §119(a) of Korean Patent Application No. 10-2012-0096713, filed on Aug. 31, 2012, the entire disclosure of which is incorporated herein by reference for all purposes.

### BACKGROUND

1. Field

The following description relates to an apparatus and a method for detecting and resolving a hang state in a terminal.

2. Discussion of the Background

Often, an application of a mobile terminal suddenly freezes and does not respond is to input. This kind of malfunction is referred to as a hang state. A system hang state indicates a situation where inputting and outputting processes of a mobile device stop performing due to software or hardware problems in the mobile device.

The hang state can be triggered largely for two reasons: (1) a malfunction of a major system component, for example, a Central Processing Unit (CPU), a kernel, and the like, or (2) a malfunction of a component responsible for inputting and outputting processes.

As mobile terminals are required to provide improved performance and more functions, their software and hardware have become more complicated. This has led to an unstable system of the mobile terminals, so that a hang state often occurs in a CPU or an Application Processor (AP) of the mobile terminals.

FIG. 1 is a flow chart illustrating the operation of a general watchdog program for detecting and resolving a hang state occurring in an AP. The general watchdog program for detecting and resolving a hang state uses a hardware timer. The watchdog program sets a target object and then initializes a watchdog timer operation 101 to trigger after a wait period. The watchdog program waits for the target object to transmit a report signal, while the watchdog timer continues to count the wait period. When the report signal is received from the target object before the watchdog timer has elapsed, the watchdog expires in operation 105 and operation 106, and the watchdog reinitializes the watchdog timer. If the report signal is not received from the target object prior to the wait timer's lapse or expiration, in operation 102, the watchdog determines that a hang state has occurred in the target object and an interrupt or hang state occurs in operation 103. The system then performs a predetermined operation in response to the occurrence of the interrupt in operation 104. The predetermined operation is usually a system reset or reboot in order to resolve the interrupt or hang state.

However, in some cases, the watchdog program fails to detect a malfunction of the target object. The watchdog program usually cannot detect a hang-state where the target object fails to occupy a CPU and thus the system freezes. When the target object that has not occupied the CPU, the target object cannot transmit a signal to initialize the watchdog program. Sometimes, even if the target object has occupied the CPU, a watchdog interrupt does not occur. For example, although an Operating System (OS) kernel module or a task to process a user interface has malfunctioned, a target object keeps occupying the CPU and the target object continues to be executed, the system may appear to be in a hang state by the user. For example, the target object transmits a report signal to a watchdog program so that the watchdog program cannot detect a hang state. But a user of the mobile terminal considers that a system hang state occurs since the user interface is not working or responding.

In addition, if there is a problem in the watchdog program itself, it is hard to detect or resolve a hang state of the watchdog program since the watchdog program is software that is executed in an AP. For example, when the AP enters a sleep mode the watchdog program is placed in a disabled state, and a hang state cannot be detected or resolved.

### SUMMARY

Exemplary embodiments of the present invention provide an apparatus and method for determining a hang state of a mobile terminal.

Additional features of the invention will be set forth in the description which follows, and in part will be apparent from the description, or may be learned by practice of the invention.

Exemplary embodiments of the present invention provide an apparatus for managing a hang state of a mobile terminal, the apparatus including: an Application Processor (AP); an input device configured to receive an input and to transmit an input signal; an input processor configured to receive the input signal and to transmit a notification signal to the AP; and a hang-state processor configured to determine that the AP is in a hang-state and to remedy the hang-state of the AP, wherein, upon receiving the notification signal, the AP requests the input signal from the input processor to process the corresponding input.

Exemplary embodiments of the present invention provide a method for managing a hang state of a mobile terminal 14. A method for managing a hang state of a mobile terminal, the method including: providing an AP; providing an input device configured to receive an input and to transmit an input signal; providing an input processor for receiving the input signal and transmitting a notification signal to the AP; requesting, by the AP, the input signal to process the corresponding input; determining that the AP is in a hang-state as the AP is not processing the input signal; and remedying a hang-state of the AP.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 illustrates an operation of a general watchdog program for detecting and is resolving a hang state occurring in an AP per the related art;

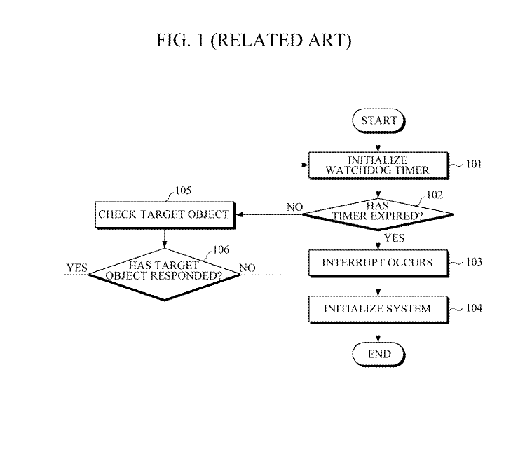

FIG. 2 illustrates an apparatus for managing a hang state of a mobile terminal according to exemplary embodiments of the present invention;

FIG. 3 illustrates an apparatus for managing a hang state of a mobile terminal according to exemplary embodiments of the present invention;

FIG. 4 illustrates a method for managing a hang state of a mobile terminal according to exemplary embodiments of the present invention;

FIG. 5 illustrates an apparatus for managing a hang state of a mobile terminal according to exemplary embodiments of the present invention;

FIG. 6 illustrates an apparatus for managing a hang state of a mobile terminal according to exemplary embodiments of the present invention;

FIG. 7 illustrates a method for managing a hang state of a mobile terminal according to exemplary embodiments of the present invention;

FIG. 8 illustrates a method for processing an input signal according to exemplary embodiments of the present invention;

FIG. 9 illustrates a method for detecting a hang state according to exemplary embodiments of the present invention; and

FIG. 10 illustrates a method for detecting a hang state according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item.

The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. If a feature is described herein as being predetermined, such feature may be determined by a manufacturer, programmer, an end user, and the like. Although some features may be described with respect to individual exemplary embodiments, aspects need not be limited thereto such that features from one or more exemplary embodiments may be combinable with other features from one or more exemplary embodiments.

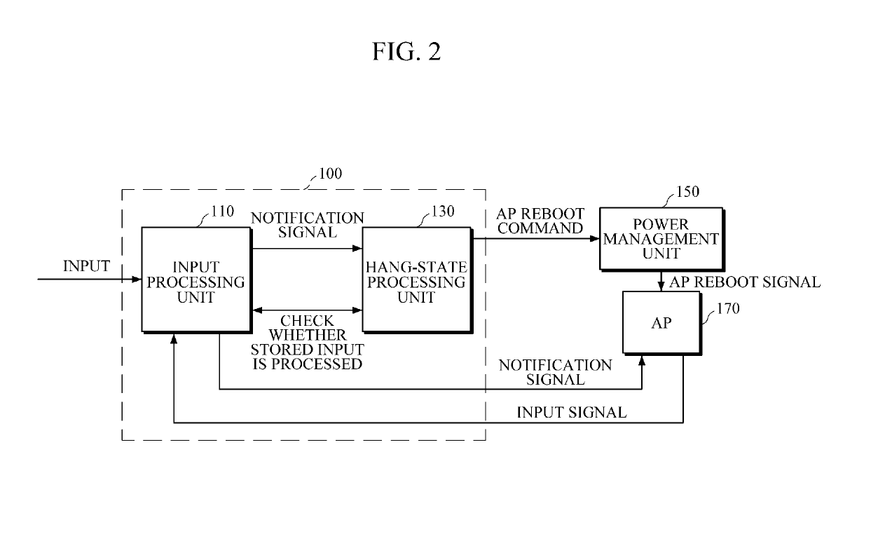

FIG. 2 is a diagram illustrating a configuration of an apparatus 100 for managing a hang state of a mobile terminal according to exemplary embodiments of the present invention.

Apparatus 100 for managing a hang state of a mobile terminal includes a user input processing unit (input processing unit/input processor) 110 and a hang-state processing unit (hang-state processor) 130.

User input processing unit 110 receives various types of inputs from mobile terminal users. A user input (input) is stored in the user input processing unit 110. User input processing unit 110 notifies the hang-state processing unit 130 and an AP 170 that the user input has been received. The apparatus 100 detects a hang state occurring in the AP 170 by checking whether the AP 170 is properly processing the user input stored in the user input processing unit 110.

AP 170 accesses the user input processing unit 110 and processes the user input. When the AP 170 is in a hang state, the AP is unable to properly process the user input stored in the user input processing unit 110.

When the AP 170 is in a hang state, any device connected directly to the AP 170, and directly or indirectly controlled by the AP 170 may have frozen or may have malfunctioned. For this reason, an input device needs to operate without being controlled directly by the AP 170. This permits a user input signal (input signal) to be received from an input device not directly controlled by the AP 170 of a mobile terminal, even though a hang has occurred in the AP 170.

Examples of the input device to receive a user input signal may include a touch screen, a voice sensor, a motion recognizing sensor and a physical button. A touch screen is a screen generally used in smart phones and recognizes an input when a user touches a display screen. The voice recognition sensor is a sensor to recognize a user's voice, input a text into a mobile terminal and control the mobile terminal using a voice command. In some embodiments, an input signal can be generated via an intermediary bus controller, for example, a USB controller, when an input device is connected to the mobile terminal via the intermediary bus controller.

The motion recognition sensor may be divided into two groups. Sensors of the first group recognize movement of a mobile terminal in which the motion recognition sensor is embedded, and may include a gyro-sensor. In addition, sensors of the second group recognize movement occurring within a sensing range about or within a proximity of the mobile terminal. For example, in the case of the motion recognition sensor of the second group, a user may answer or hang up a phone by waving a hand toward a mobile terminal. The physical buttons are buttons arranged on a surface of the mobile terminal and may include, for example, a home button or a volume control button of a smart phone.

When the AP 170 of a mobile terminal is in the hang state, the hang state may be detected and resolved using a touch signal which is input through a touch screen of a smart phone or a tablet PC. A touch signal of the touch screen may include an arbitrary touch signal, a predetermined touch signal or sequence of touch signals at a location (coordinates), or a predetermined move or sequence of moves.

When a user input signal is received via the voice recognition sensor, the hang state of the AP 170 may be detected using a voice signal which is input by a user. When a user input signal is received via the motion recognition sensor, a user's predetermined hand or body movement or movement of the mobile terminal can be recognized to detect and resolve the hang state of the AP 170.

The above-described input devices for receiving a user input signal are merely exemplary, and aspects of the present invention are not limited thereto and may include all types of input devices which are not directly or indirectly controlled by the AP 170 of a mobile terminal. In other words, exemplary embodiments of the present invention may use an input device to detect a hang state of the mobile terminal, such as a touch screen and a voice recognition sensor embedded in smart phones or other mobile terminals in which the input device is not directly or indirectly controlled by the AP 170. The input device may operate independently of the AP 170.

The user input processing unit 110 generates a notification signal based on a user input received through an input device. Specifically, when a user input signal is received from a user, the user input processing unit 110 generates a notification signal to notify the hang-state processing unit 130 that the user input signal has been received. The generated notification signal is transmitted to the hang-state processing unit 130.

The user input processing unit 110 may generate a user input signal based on the user input received through the input device. Input processing unit 110 generates a user input signal including information about the user input and the user input and the input signal is processed or recognized by the AP 170. The information about the user input is processed according to an input device type. For example, when a touch input signal (or the user input signal) is received through a touch input device, information about coordinates at which a screen a user touches on a screen, may be generated based on the touch input signal. The information about the coordinates may include touch input coordinates of the touch input signal on the touch input device. When a voice is received through a voice input device, voice information is generated based on a voice input signal. When a motion signal is received through a motion recognition device, motion information is generated based on the motion signal.

The user input signal generated by the user input processing unit 110 may be used as data for detecting that the AP 170 of the mobile terminal is in a hang state. In order to detect the hang state, the user input signal may be generated and transmitted in a different manner or in the same manner as an input signal that is generated and transmitted to the AP 170 when receiving a general touch input, motion input, or voice input. The user input processing unit 110 may receive the user input signal using an input device included in the user processing unit 110. User input processing unit 110 may receive the input signal using a commonly-used input device.

Input processing unit 110 may use a commonly-used input device without an additional device or configuration to detect a hang state, for example, when data is transmitted to the AP 170 in a same or similar manner as a touch signal which is input through a touch screen.

Hang-state processing unit 130 is notified that the user input signal has been received using the notification signal received from the input processing unit 110. Apparatus 100 detects that the AP 170 is in a hang state, according to whether the AP 170 is properly processing a user input. Hang-state processing unit 130 checks the hang-state of the user input processing unit 110 when the notification signal is received from the user input processing unit 110.

The hang-state processing unit 130 checks whether the AP 170 of apparatus 100 is processing the received user input signal. If the AP 170 is notified that the user input signal has been received, the AP 170 performs an operation to process the user input signal. If the AP 170 is operating properly, the AP 170 is able to process the user input signal without any difficulty. However, if the AP 170 freezes or malfunctions, the AP 170 is unable to process the user input signal properly. Thus, the hang-state processing unit 130 may determine whether the AP 170 is operating properly, by checking whether the AP 170 is processing the user input signal properly.

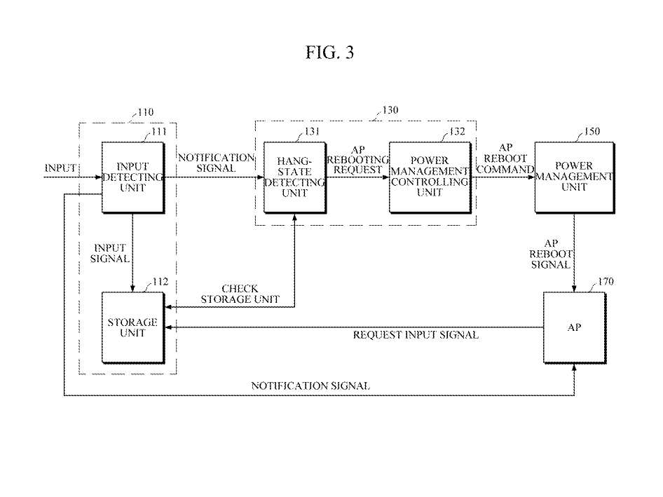

If the AP 170 is not processing the received user input signal properly, the hang-state processing unit 130 determines that the AP 170 is in a hang state, and performs an operation to resolve the hang state of the AP 170. To resolve the hang state of the AP 170, the hang-state processing unit 130 transmits an AP reboot command or an AP reset command to a power management unit 150. In response to receiving the AP reboot command from the hang-state processing unit 130, the power management unit 150 reboots the AP 170 to resolve the hang state of the AP 170. Detailed descriptions about the hang-state processing unit 130 will be provided with reference to FIGS. 3 to 5.

In response to the AP reboot command received from the hang-state processing unit 130, the power management unit 150 controls power supply of the AP 170 to reboots the AP 170.

The power management unit 150 controls a power supply (not shown) of apparatus 100. An exemplary power management unit includes a Power Management IC (PMIC) used to boost the battery life of a mobile terminal. One role of the PMIC is to make core voltage suitable for the CPU (or AP), thereby enabling the CPU (or AP) to operate with minimum power consumption. The PMIC can operate in response to receiving an interface signal which corresponds to loads to be processed by a CPU (or AP).

FIG. 3 illustrates an apparatus for managing a hang state of a mobile terminal according to exemplary embodiments of the present invention. User input processing unit 110 can include an input detecting unit 111 and a storage unit 112. Hang-state processing unit 130 can include a hang-state detecting unit 131 and a power management controlling unit 132.

In response to receiving a new user input, the user input detecting unit 111 can generate an input received notification signal and can transmit the notification signal to the hang-state detecting unit 131 and the AP 170. Input detecting unit 111 can generate a user input signal including the received user input and store the user input signal in the storage unit 112.

The storage unit 112 stores the user input signal received from the user input detecting unit 111. Storage unit 112 may transmit the stored user input signal upon receiving a signal from AP 170. The storage unit 112 may be included in the user input processing unit 110 or may be separate from the user input processing unit 110 and/or the terminal.

In response to the notification signal received from the user input processing unit 110, the hang-state detecting unit 131 checks the storage unit 112 to determine whether the AP 170 is in a hang state. Storage unit 120 can store a signal which is input through an input device to a mobile terminal and then transmit the stored signal to the AP 170.

In response to receiving the input signal from the user, the user input processing unit 110 generates the user input signal including information about the user input, stores the user input signal in the storage unit 112, and transmits an interrupt (or a notification signal) to the

AP 170 with respect to the input signal. If AP 170 is operating properly, the AP 170 accesses the storage unit 112 and reads the stored user input signal. However, if the AP 170 is in a hang state and thus unable to operate properly, the AP 170 is unable to access the storage unit 112 to read the stored user input signal.

The hang-state detecting unit 131 checks the storage unit 112 to see whether the AP 170 accessed the storage unit 112 and read the stored user input signal properly. If the AP 170 is not reading the stored user input signal, the hang-state detecting unit 131 determines that the AP 170 is in a hang state, and transmits an AP rebooting request to the power management controlling unit 132.

In response to receiving the AP rebooting request, power management controlling unit 132 transmits an AP reboot command to the power management unit 150 and reboots the AP 170.

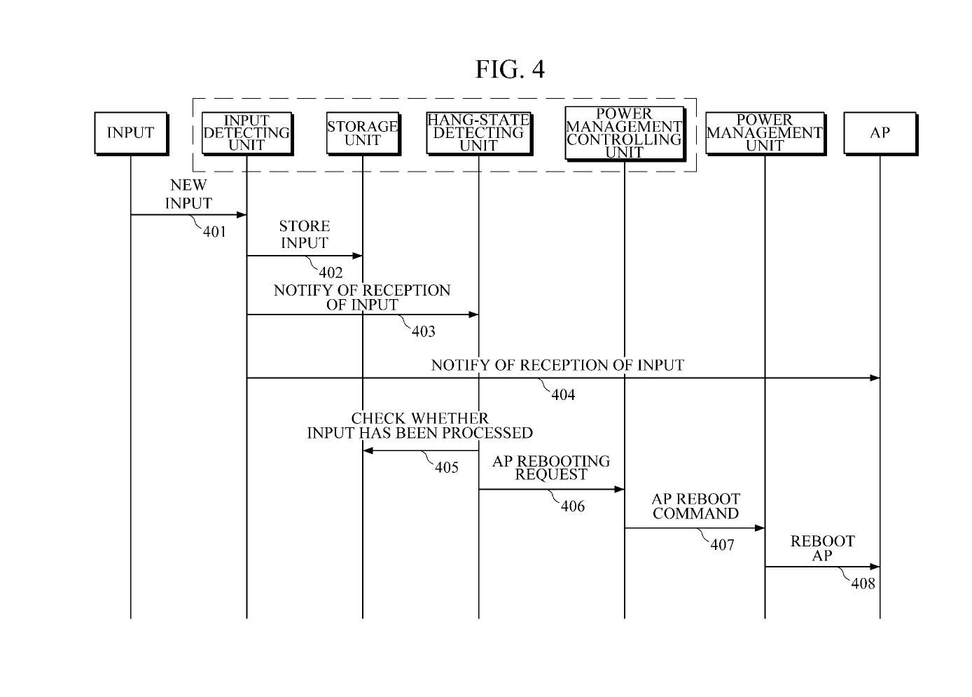

FIG. 4 illustrates a method for managing a hang state of a mobile terminal according to exemplary embodiments of the present invention. A new user input from a user is received in a user input detecting unit in operation 401. The user input may be received through various types of input devices including a touch input device, a voice input device, and a motion recognition device. The received user input is transmitted to a storage unit in operation 402. In addition, the user input detecting unit notifies a hang-state detecting unit that the user input has been received in operation 403, and notifies an AP of a mobile terminal that the user input has been received in operation 404.

Next, the hang-state detecting unit checks whether user input has been processed in operation 405. The hang-state detecting unit is able to check the storage unit to determine whether the AP accessed the storage unit. In some embodiments, the hang-state detecting can check if the input was processed properly. If the AP is not properly processing the user input stored in the storage unit, the hang-state detecting unit determines that the AP is in a hang state, and transmits an AP rebooting request to a power management controlling unit in 406. In response to receiving the AP rebooting request, the power management controlling unit transmits an AP reboot command to the power management unit which controls power supply of a mobile terminal in 407. The power management unit reboots the AP according to the received AP reboot command in 408.

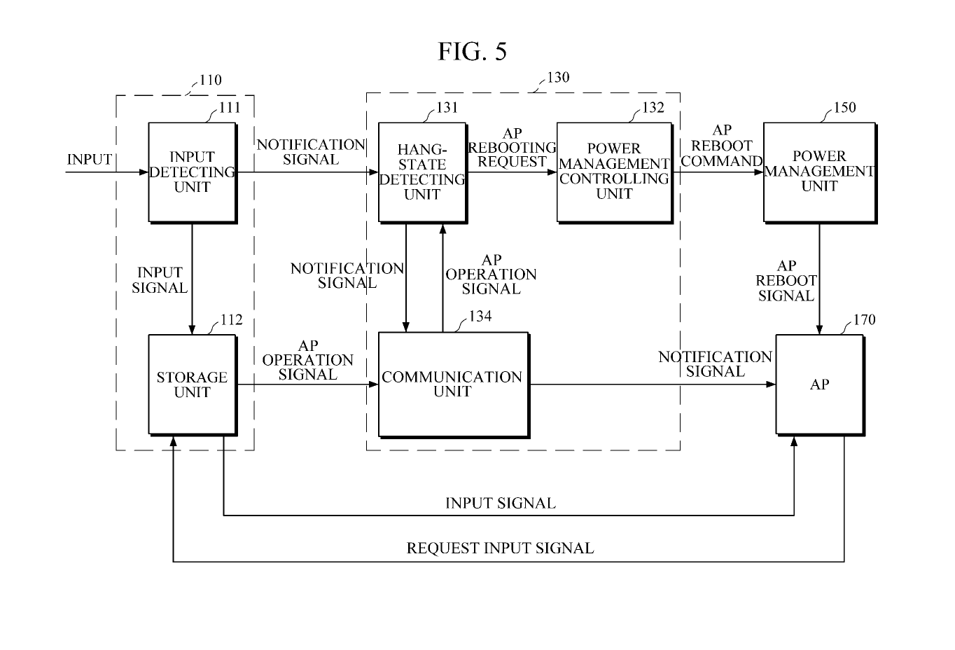

FIG. 5 illustrates an apparatus for managing a hang state of a mobile terminal according to exemplary embodiments of the present invention. Input processing unit 110 includes the user input detecting unit 111 and the storage unit 112. In addition, the hang-state processing unit 130 includes the hang-state detecting unit 131, the power management controlling unit 132 and a communication unit 134.

In response to receiving a new user input, the user input detecting 111 generates a notification signal indicating that the new user input has been received, transmits the notification signal to the hang-state detecting unit, and stores a user input signal including the received user input in the storage unit 112.

The Storage unit 112 stores the user input signal received from the user input detecting unit 111. In addition, in response to receiving a request for the user input signal from the AP 170, the storage unit 112 transmits the stored user input signal to the AP 170. In addition, if the AP 170 receives the user input signal, the storage unit 112 transmits to the communication unit 134 an AP operation signal indicating that the AP is operating properly.

Using the notification signal received from the user input processing unit 110, the hang-state detecting unit 131 checks whether the AP 170 is in a hang state, and transmits the received notification signal to the AP 170 through the communication unit 134. In response to receiving the notification signal, the AP 170 accesses the storage unit 112 and reads the user input signal. If the AP 170 reads the user input signal stored in the storage unit 112, the AP operation signal is transmitted to the hang-state detecting unit 131 through the communication unit 134.

If after a time period, the AP operation signal is not received from the communication unit 134, the hang-state detecting unit 131 determines that the AP 170 is in a hang state, and transmits an AP rebooting request to the power management controlling unit 132.

In response to receiving the AP rebooting request from the hang-state detecting unit 131, the power management controlling unit 132 transmits an AP reboot command to control the power management unit 150. In response to receiving the AP reboot command from the power management controlling unit 132, the power management unit 150 reboots the AP 170 to resolve the hang state of the AP 170.

The Communication unit 134 enables communication among the hang-state detecting unit 131, the AP 170 and the storage unit 112. Specifically, the communication unit 134 transmits to the AP 170 a notification signal received from the hang-state detecting unit 131. If the AP 170 reads a user input signal in the storage unit 112, the communication unit 134 receives an AP operation signal from the storage unit 112 and transmits the AP operation signal to the hang-state detecting unit 131.

Communication unit 134 may be an Inter-Processor Communication (IPC) between processors. The IPC is a set of communication methods between processors. According to the IPC methods, communicable processors may share a predetermined variable and exchange data using the predetermined variable. In some embodiments, an operating system may enable communication among processors to exchange data.

As hang-state processing unit 130 of FIG. 5 does not include the communication unit 134, the hang-state detecting unit 131 is responsible for notifying the AP 170 that the user input processing unit 110 has received a user input signal. Hang-state processing unit may receive the AP operation signal from the storage unit 112 through the communication unit 134 to determine whether the AP 170 is operating properly and processing the received user input signal.

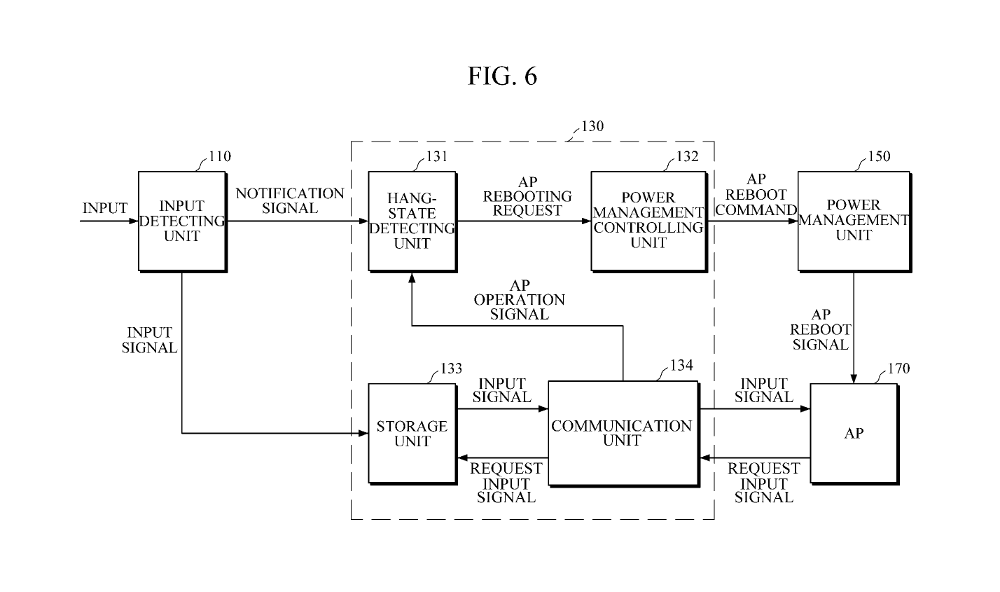

FIG. 6 illustrates an apparatus for managing a hang state of a mobile terminal according to exemplary embodiments of the present invention. Hang-state processing unit 130 includes the hang-state detecting unit 131, the power management controlling unit 132, the communication unit 134 and a storage unit 133.

The hang-state detecting unit 131 receives a notification signal from the user input processing unit 110 and prepares to detect a case when the AP 170 is in a hang state. If the hang- state detecting unit 131 does not receive an AP operation signal which indicates that the AP 170 is properly processing the user input signal in the storage unit 133, the hang-state detecting unit 131 determines that the AP 170 is in a hang state, and transmits an AP rebooting request to the power management controlling unit 132.

The power management controlling unit 132 receives the AP rebooting request from the hang-state detecting unit 131. In response to the AP rebooting request, power management controlling unit 132 sends an AP reboot command to power management unit 150. In response to receiving the AP reboot command, the power management unit 150 reboots the AP 170 to resolve a hang state of AP 170.

The communication unit 134 enables communication between the hang-state detecting unit 131, the AP 170 and the storage unit 133. Specifically, the communication unit 134 receives a notification signal from the hang-state detecting unit 131 and transmits a notification signal to the AP 170. If the AP 170 reads a user input signal in the storage unit 133, the communication unit 134 receives an AP operation signal from the storage unit 133 and transmits the AP operation signal to the hang-state detecting unit 131.

The storage unit 133 located in the hang-state processing unit 130 (rather than in the user input processing unit 110) receives the user input signal from the user input processing unit 110 and stores the user input signal. The user input signal is generated in the user input processing unit 110 based on a user input. Through the communication unit 134, the storage unit 133 notifies the AP 170 that the user input signal has been received. In addition, when the AP 170 accesses the storage unit 133 through the communication unit 134 and requests the stored user input signal, the storage unit 133 transmits the stored user input signal to the AP 170. The storage unit 112 may be included in the hang-state processing unit 130 or may be separate from the hang-state processing unit 130 and/or the terminal.

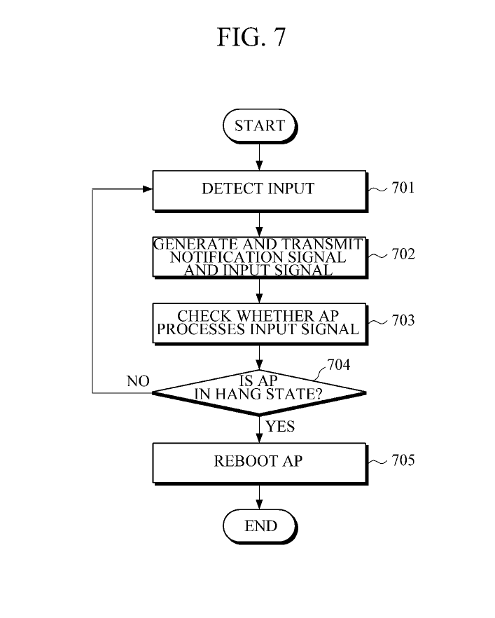

FIG. 7 illustrates a method for managing a hang state of a mobile terminal according to exemplary embodiments of the present invention. The method for managing a hang state of a mobile terminal starts out by detecting a user input in operation 701. When an AP of a mobile terminal is in a hang state, an input device controlled by the AP may freeze or may be malfunctioned. Thus, the input device, which receives a signal from a user upon an occurrence of a hang in the AP, should not be directly or indirectly controlled by the AP and may be at least partially controllable independent of the AP. The input device may include all types of input devices which are not under control of the AP. For example, the input device may be a touch screen, a voice input device, or and a motion recognition device of a mobile terminal.

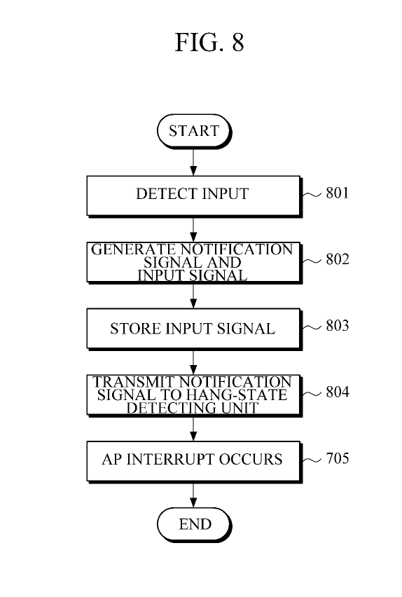

Next, a notification signal and a user input signal are generated based on the user input and transmitted in operation 702. Specifically, the notification signal and the user input signal are generated based on the user input, and information about the generated user input signal is stored. In addition, the reception of the user input signal is notified of the AP in order to detect whether the AP is in a hang state. An example of the method for processing the user input signal will be provided with reference to FIG. 8.

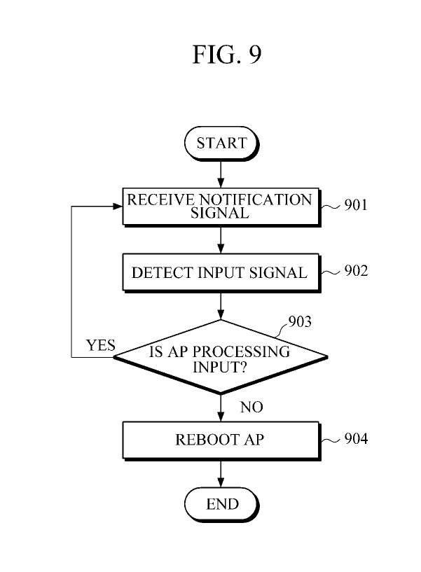

Next, whether the AP is properly processing the user input signal is checked in operation 703. Specifically, whether the AP is in a hang state may be detected by checking whether the AP is properly processing the received user input signal. Next, whether the AP is in a hang state is determined in operation 704. If the AP is operating properly, the AP informed that the user input signal has been received accesses the stored information about the user input signal and is processing the user input signal. If the AP is properly processing the received user input signal, it is determined that AP is operating properly, and it is prepared for a new user input signal. An example of the method for checking operations of the AP to detect whether the AP is in a hang state will be provided with reference to FIG. 9.

When the AP is in a hang state, an AP reboot command is transmitted in operation 705. Specifically, if the AP is not properly processing the received user input signal, it is determined that the AP is in a hang state, and an AP reboot command is transmitted to resolve the hang state. The AP reboot command is used to control power supply of the AP so as to reboot the AP.

FIG. 8 is a flow chart illustrating a method for processing a user input signal according to exemplary embodiments of the present invention.

Referring to FIG. 8, a user input received through an input device and detected in operation 801. Specifically, a user input received through various types of input devices, for example, a touch screen, a voice input device, and/or a motion recognition device, may be detected. Next, a notification signal and a user input signal are generated based on the detected user input in operation 802. Specifically, the notification signal is generated to notify a hang-state detecting unit that the user input signal has been received based on the detected user input.

The generated notification signal is transmitted to the hang-state detecting unit. In response to receiving the notification signal, the hang-state detecting unit is notified that an operation to detect whether a hang state has occurred has begun due to the reception of the user input signal. The notification signal may be generated based on the user input, or the generated user input signal may be used as the notification signal. Next, the generated user input signal is stored in 803. The user input signal may be stored in a storage unit of an apparatus for managing a hang state of a mobile terminal according to exemplary embodiments of the present invention or may be stored in a storage device which is not included in the apparatus for managing a hang state of a mobile terminal but able to communicate with an AP, as shown for example, in FIG. 3 and FIG. 5.

The reception of the new user input signal is notified of the hang-state detecting unit in order to detect whether the AP is in a hang state in operation 804. The hang-state detecting unit may be notified that the user input signal has been received, using the notification signal generated based on the user input or using the received user input signal.

Next, an AP interrupt occurs in operation 805. Specifically, the AP interrupt occurs so that the AP processes the received user input signal. The AP interrupt may be generated based on the user input signal stored in the storage unit, or may be generated based on the notification signal transmitted from the hang-state detecting unit. Due to the occurrence of the AP interrupt, the AP is notified that the user input signal has been received, and reads the user input signal stored in the storage unit.

FIG. 9 is a flow chart illustrating a method for detecting a hang according to exemplary embodiments of the present invention.

A notification signal to detect whether a hang state has occurred is received in operation 901. A notification signal can be generated, for example, by the user input processing unit 110. A hang-state detecting unit which has received the notification signal checks or determines whether an AP processes a stored user input signal in 902. In a broad sense, the hang-state detecting unit may use at least one of at least two methods for checking whether the AP is operating properly and processing the user input signal: (1) the hang-state detecting unit may check the user input signal stored in the storage unit to determine whether the AP is properly processing the user input signal stored in the storage unit, or (2) may check a communication unit, which enables communication between the storage unit and the AP, to determine whether the AP is processing the user input signal properly.

Next, whether the AP is properly reading the user input signal is determined in operation 903. Specifically, whether the AP is properly reading the user signal is determined by checking the storage unit or the communication unit, so that whether the AP is in a hang state may be determined. If the AP is not processing the user input signal properly, it is determined that the AP is not in a hang state and then it is prepared to receive a new user input signal. However, if the AP is not properly processing the user input signal, it is determined that the AP is in a hang state.

Next, an AP reboot command is transmitted in operation 904. Specifically, if the AP is not properly processing the user input signal, it is determined that the AP is in a hang state, and the AP reboot command is transmitted to the power management unit. In response to the AP reboot command, the power management unit controls power supply of the AP to reboot the AP.

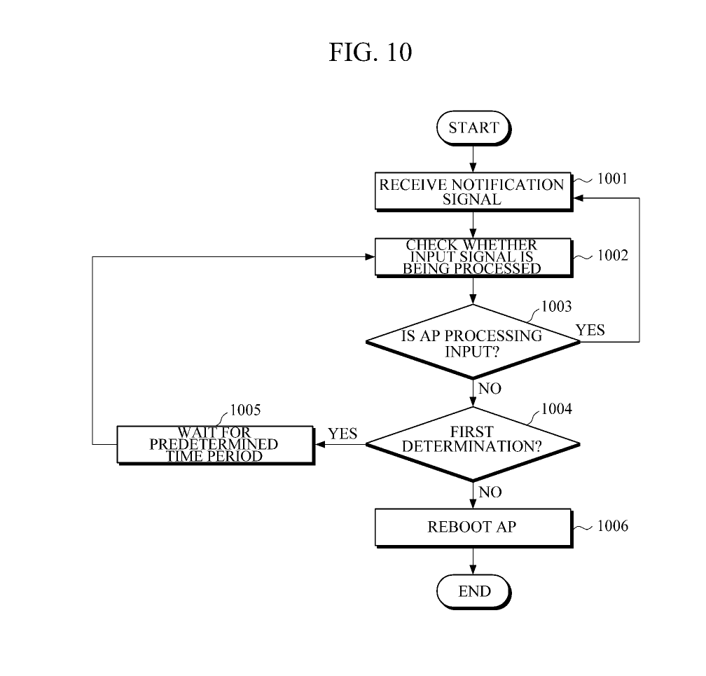

FIG. 10 is a flow chart illustrating a method for detecting a hang according to exemplary embodiments of the present invention.

A notification signal to detect whether a hang state has occurred is received in operation 1001, as described above with reference to operations 901 and 902 of FIG. 9. Next, whether the AP processes a stored user input signal is checked in operation 1002. Specifically, whether the AP is properly reading the user input signal stored in a storage unit may be determined by checking the storage unit or a communication unit.

Next, whether the AP is properly reading the user input signal is determined in operation 1003. If the AP is properly processing the user input signal, it is determined that the AP is not in a hang state, and the AP is prepared for a new user input signal. However, if the AP is not properly processing the user input signal, it is determined that the AP is in a hang state.

If it is determined that the AP is in a hang state, it is checked whether such determination has been made for the first time in operation 1004. In other words, the AP may be unable to read the user input signal for at least one of at least two reasons: (1) a hang state occurring in the AP or other drawbacks caused by an inner communication failure, a power supply problem and an application malfunction, or (2) because the AP is not processing a user input signal immediately or within a reference time after the user input signal is received. Thus, if it is the first time to determine that the AP is in a hang state, the mobile terminal may recheck whether the AP is properly reading the user input signal, rather than transmitting an AP reboot command.

If it is the first time to determine that the AP is in a hang state, whether the AP is processing the user input signal is rechecked after a predetermined wait time in operation 1005. That is, if it is the first time to determine that the AP is in a hang state, the recheck operation is performed. Specifically, after the first check, a predetermined wait time proceeds and then the recheck operation is performed.

However, if it is not the first time to determine if the AP is in a hang state, an AP reboot command is transmitted in 1006. That is, if it is not the first time to determine whether the AP is in a hang state, it is determined that the AP is in a hang state and an AP reboot command is transmitted to a power management unit.

A predetermined wait time required to recheck whether the AP is in a hang state may vary according to how long the wait time is set to be, and the wait time may be set by a manufacturer, designer, programmer, user, etc. In addition, the second check operation may be performed one or more times according to settings and state of a mobile terminal.

Using the apparatus and the method for managing a hang state of a mobile terminal according to exemplary embodiments of the present invention, it is possible to effectively detect the hang state occurring in the mobile terminal and automatically reboot an AP, thereby resolving the hang state. In addition, in the case when the AP has a problem and thus cannot operate properly, a watch dog program may be compromised, but the apparatus for managing a hang state of a mobile terminal is still able to detect the hang state since the apparatus uses hardware independent of the AP of the mobile terminal.

Although exemplary embodiments of the present invention were disclosed with respect to unlocking a touch screen of the electronic device, aspects of the invention are not limited thereto, such that the unlocking operation may be applied to the electronic device itself, an application, an operation, an event, and the like.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus for managing a hang state of a mobile terminal, the apparatus comprising:
an Application Processor (AP);
an input device configured to receive an input and to transmit an input signal;
an input processor configured to receive the input signal and to transmit a notification signal to the AP; and
a hang-state processor configured to determine that the AP is in a hang-state and to remedy the hang-state of the AP,
wherein, upon receiving the notification signal, the AP requests the input signal from the input processor to process the corresponding input.

2. The apparatus of claim 1, wherein the hang-state processor determines that the AP is in a hang-state when the AP is not processing the input signal after the input signal is received.

3. The apparatus of claim 1, wherein the hang-state processor remedies the hang-state by rebooting the AP.

4. The apparatus of claim 3, further comprising a power management controller configured to process an AP reboot request from the hang-state processor.

5. The apparatus of claim 4, further comprising a power manager configured to process an AP reboot command from the power management controller.

6. The apparatus of claim 1, wherein, prior to remedying the hang state, the hang-state processor determines whether a current hang state is a first instance of the AP being in a hang state, and, if the current hang state is a first instance, the hang-state processor re-determines whether the AP is processing the input signal.

7. The apparatus of claim 1, wherein the input processor comprises a storage configured to receive the input signal to be processed by the AP.

8. The apparatus of claim 7, wherein the hang-state processor determines that the AP is not processing the input signal by determining if the stored input signal has been accessed by the AP.

9. The apparatus of claim 7, further comprising a communications processor configured to communicate a signal to and from the AP and the storage.

10. The apparatus of claim 1, wherein the hang-state processor comprises a storage configured to receive the input signal to be processed by the AP.

11. The apparatus of claim 10, wherein the hang-state processor determines that the AP is not processing the input signal by determining if the stored input has been accessed by the AP.

12. The apparatus of claim 1, wherein the input device is not directly connected to the input processor.

13. The apparatus of claim 1, wherein the notification signal is also transmitted to the hang-state detecting processor.

14. A method for managing a hang state of a mobile terminal, the method comprising:
providing an AP;
providing an input device configured to receive an input and to transmit an input signal;
providing an input processor for receiving the input signal and transmitting a notification signal to the AP;
requesting, by the AP, the input signal to process the corresponding input;
determining that the AP is in a hang-state as the AP is not processing the input signal; and
remedying a hang-state of the AP.

15. The method of claim 14, wherein the determining comprises determining that the AP is in the hang-state when the AP is not processing the input signal after the input signal is received.

16. The method of claim 14, wherein the remedying comprises rebooting the AP.

17. The method of claim 16, further comprising providing a power management controller for rebooting the AP.

18. The method of claim 14, wherein, prior to remedying the hang-state, determining whether a current hang state is a first instance of the AP being in a hang state, and, if the current hang state is the first instance, re-determining whether the AP is processing the input signal.

19. The method of claim 14, further comprising storing the input signal to be processed by the AP in a storage.

20. The method of claim 19, wherein the determining comprises determining if the stored input signal has been accessed by the AP.

21. The method of claim 19, further comprising providing a communications processor to communicate a signal to and from the AP and the storage.

22. The method of claim 14, wherein the input device is not directly connected to the input processor.

23. The method of claim 14, wherein the determining is provided by a hang-state detecting processor and the notification signal is also transmitted to the hang-state detecting processor.
